(19) United States
(12) Patent Application Publication
(10) Pub. No.: US 2012/0317469 A1
(43) Pub. Date: Dec. 13, 2012

(54) DEVICE, METHOD, AND COMPUTER READABLE MEDIUM FOR PROVIDING FORMS

(75) Inventors: Takaaki KATO, Ishikawa (JP); Go DOJO, Ishikawa (JP); Yuusuke MIZUNO, Ishikawa (JP)

(73) Assignee: PFU LIMITED, Ishikawa (JP)

(21) Appl. No.: 13/449,935

(22) Filed: Apr. 18, 2012

(30) Foreign Application Priority Data
Jun. 8, 2011 (JP) 2011-128401

(51) Int. Cl. G06F 17/00

(52) U.S. Cl. 715/223

(57) ABSTRACT

There is provided a form providing device comprising: a template storage unit that stores a template of a form; an edited information storage unit that stores information about edit processing on the template selected by a user in condition where it is correlated with the selected template; and a form providing unit that provides an edited form to the user based on the information about the edit processing stored in the edited information storage unit and the template correlated with this information.

### CROSS-REFERENCE TO RELATED APPLICATIONS

This application is based on and claims priority under 35 USC 119 from Japanese Patent Application No. 2011-128401 filed Jun. 8, 2011.

### BACKGROUND OF THE INVENTION

1. Field of the Invention

The present invention relates to a form providing method.

2. Summary of the Invention

According to an aspect of the invention, there is provided a form providing device comprising: a template storage unit that stores a template of a form; an edited information storage unit that stores information about edit processing on the template selected by a user in condition where it is correlated with the selected template; and a form providing unit that provides an edited form to the user based on the information about the edit processing stored in the edited information storage unit and the template correlated with this information.

According to another aspect of the invention, there is provided a form providing device comprising: a first storage unit that stores a form definition including at least a basic layout of a form; a second storage unit that stores an image element added to the form definition selected by a user or attribute information of the image element of the selected form definition in condition where it is correlated with the selected form definition; and a form providing unit that provides the form to the user based on the image element or attribute information stored in the second storage unit and the form definition stored in the first storage unit.

According to another aspect of the invention, there is provided a form providing method comprising the steps of: selecting a template from the templates of forms; performing edit processing on the selected template in response to a command from a user; storing information about the edit processing in a storage device different from the template; and providing the form to the user based on the stored information about the edit processing and the selected template.

According to another aspect of the invention, there is provided a non-transitory computer-readable medium storing thereon a computer program used in a computer, the computer program causing the computer to perform the steps of: selecting a template from the templates of forms; performing edit processing on the selected template in response to a command from a user; storing information about the edit processing in a storage device different from the template; and providing the form to the user based on the stored information about the edit processing and the selected template.

### BRIEF DESCRIPTION OF THE DRAWINGS

Exemplary embodiments of the present invention will be described in detail based on the following figures, wherein:

FIG. 1 is an explanatory view of an outline of a form management method;

FIG. 2 is a table schematically showing an overall configuration of a business system;

FIG. 3A is a diagram exemplifying a function configuration of a form providing device 10;

FIG. 3B is a table exemplifying an authority management table which is managed by the form providing device 10;

FIG. 4 is a sequence diagram of a form edit phase;

FIG. 5 is a sequence diagram of a form output phase;

FIG. 6 is an explanatory flowchart of operations of the form providing device 10 at the time of outputting the form;

FIG. 7 is a table exemplifying an edited information management table;

FIG. 8 is an explanatory diagram of contents of attribute information and a method for applying the attribute information and monogrammed information at the time of outputting the form;

FIG. 9 is an explanatory diagram of an example of utilizing the edited information;

FIG. 10 is an explanatory diagram of updating of places common to the forms;

FIG. 11 is an explanatory diagram of a comparison example of the form providing method; and

FIGS. 12A and 12B are explanatory diagrams of problematic points of the comparison example.

### DESCRIPTION OF THE PREFERRED EMBODIMENTS

The following will describe an embodiment of the present invention with reference to the drawings.

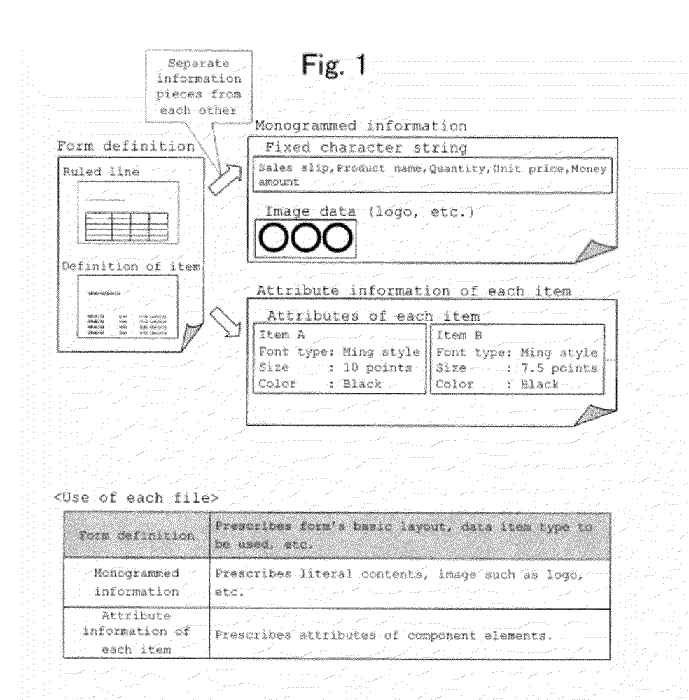

FIG. 1 is an explanatory view of the outline of a form management method.

As exemplified in FIG. 1, a form management system 1 of the present embodiment manages a form by separating it into a form definition, monogrammed information, and attribute information of each item. The definition of a form refers to basic information of the form that includes a basic layout of the form. The form definition in the present embodiment includes a basic layout of the form and a data item type to be used. The monogrammed information refers to one example of edited information according to the present invention and may be a fixed character string (for example, “sales slip”, “product name”, “quantity”, or “unit price”) or image data such as a logo (an image element added by a user, etc.). The attribute information of each item refers to information which prescribes attributes (for example, display aspect) of an image element (item, etc.) of a form and may be, for example, a font type, a font size, a font color, a line type, a line width or a line color.

The form management system 1 of the present embodiment streamlines the creation or operation of a form by managing it in condition where it is separated into a form definition, monogrammed information, and attribute information.

In the following description, a case is used as a specific example in which the form definition is provided as a template by the form management system 1 so that the monogrammed information or the attribute information may be generated by user edit operations.

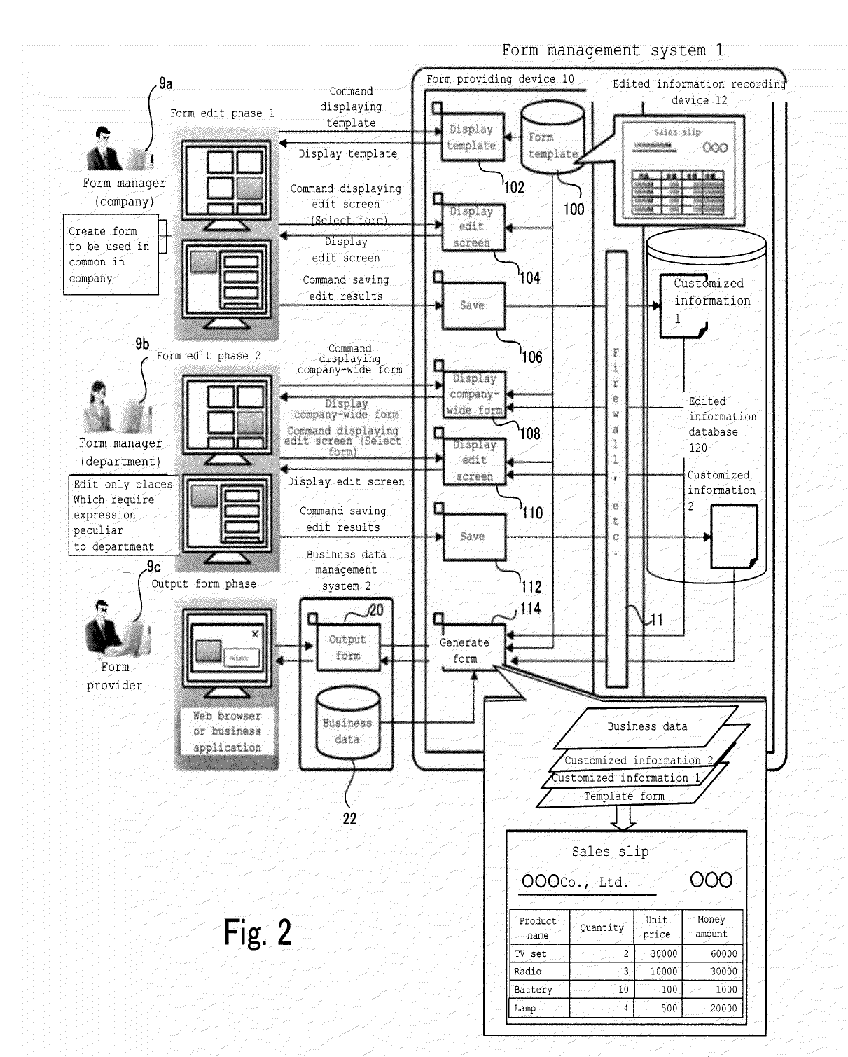

FIG. 2 is a table schematically showing the overall configuration of a business system.

As exemplified in FIG. 2, the business system has the form management system 1 and a business data management system 2.

The form management system 1 has a form providing device 10 and an edited information recording device 12. A recording region in the form providing device 10 is one example of first storage means according to the present invention, and the edited information recording device 12 is one example of second storage means according to the present invention. The form providing device 10 is connected to the edited information recording device 12 via network security equipment such as a firewall. That is, the security level of the edited information recording device 12 is higher than that of the form providing device 10.

In response to a request from the user, the form management system 1 of the present embodiment provides the template of a form and customizes the form, inserts business data managed in the business data management system 2 into the customized form, and provides it to the user.

The business data management system 2 has a business database 22 in which business data is stored, to manage the business data.

The form providing device 10 is a computer terminal in which a form providing program 5 to be described later is installed. The form providing device 10 of the present embodiment is also a web server, to provide a client terminal 9 of the user with a template display function 102, an edit screen display function 104, an edited information saving function 106, a company form display function 108, an edit screen display function 110 for further editing, a further edited information saving function 112, and a form generation function 114.

In the following description of the embodiment, as a specific example, a case is given in which a company-wide form manager operates a client terminal 9a to select a form's template and customize (edit) company-wide common portions for the selected template, a form manager of each of departments operates a client terminal 9b to perform department-specific editing on the form having the customized company-wide common portions, and a form provider operates a client terminal 9c to output the customized form. That is, the form providing device 10 has a template database 100 which stores forms which provide templates and uses the template display function 102 to display the form templates to the client terminal 9a and accept selection of a desired template.

Further, the form providing device 10 uses the edit screen display function 104 to accept edit operations on the selected template from the client terminal 9a and perform edit processing on the selected template. Moreover, the form providing device 10 uses the saving function 106 to save the resultant edited information (customized information 1) in the edited information recording device 12.

Further, the form providing device 10 uses the company-wide form display function 108 to display the form having the form customized by the client 9a to the client terminal 9b and uses the edit screen display function 110 to accept a further edit operation so that further edit processing may be performed on the customized template. Moreover, the form providing device 10 uses the saving function 112 to save the resultant edited information (customized information 2) in the edited information recording device 12.

Finally, in response to a request from the client terminal 9c, the form providing device 10 uses the form generation function 114 to generate a form to which the customized information 1 and the customized information 2 are applied and inserts business data into the generated form (which is already customized).

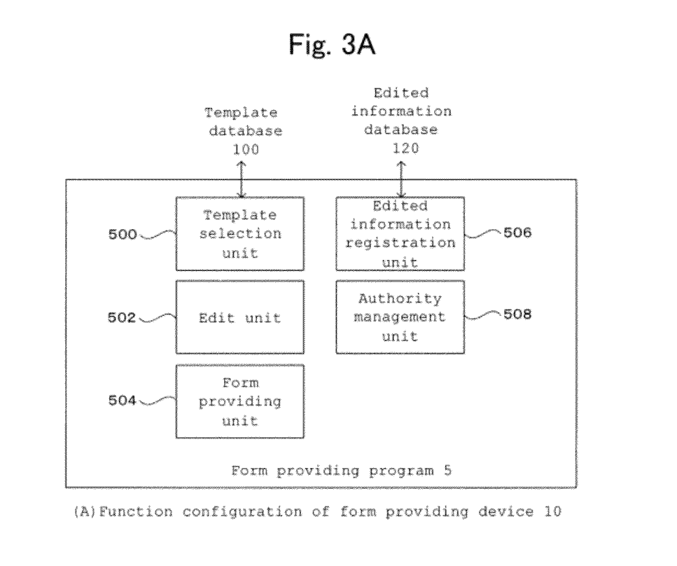

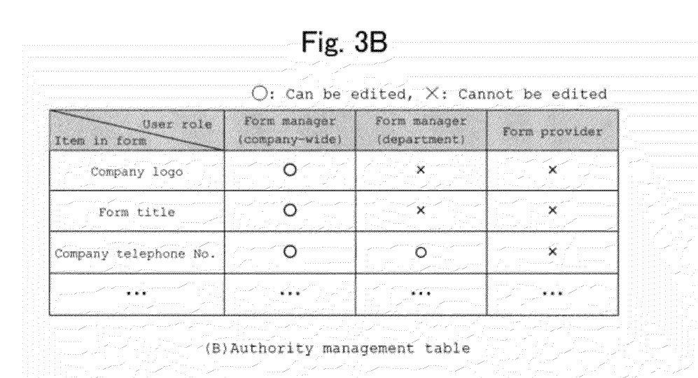

FIG. 3A is a diagram exemplifying a function configuration of the form providing device 10 and FIG. 3B is a table exemplifying an authority management table which is managed by the form providing device 10.

As exemplified in FIG. 3A, a form providing program 5 has a template selection unit 500, an edit unit 502, a form providing unit 504, an edited information registration unit 506, and an authority management unit 508.

The template selection unit 500 presents the user with form templates stored in the template database 100 in the form providing device 10 by referencing this template database 100, thereby selecting one of the templates which is to be edited in accordance with user's selection operations. Further, the template selection unit 500 presents the customized template to the user, to select one of the customized templates as something to be further edited in accordance with the user's selection operations. That is, the template selection unit 500 implements the template display function 102 and the company-wide form display function 108 in FIG. 2.

In accordance with the user operations, the edit unit 502 performs edit processing on the template selected by the template selection unit 500. The edit processing involves addition (monogramming) of an image element such as a fixed character string or a logo image or alteration of attributes of the image element. That is, the edit unit 502 implements the edit screen display functions 104 and 110 in FIG. 2.

The form providing unit 504 generates a customized form based on the form template stored in the template database 100 and the edited information stored in an edited information database 120 in the edited information recording device 12 and provides the generated form to the user. That is, the form providing unit 504 implements the form generation function 114 in FIG. 2.

The edited information registration unit 506 registers information about the edit processing performed by the edit unit 502 in the edited information recording device 12 in condition where it is correlated with the template subjected to editing. More specifically, the edited information recording device 12 includes the edited information database 120, so that the edited information registration unit 506 registers the monogrammed information or the attribute information for the edit processing performed by the edit unit 502 in the edited information database 120 in condition where it is correlated with the template subjected to editing.

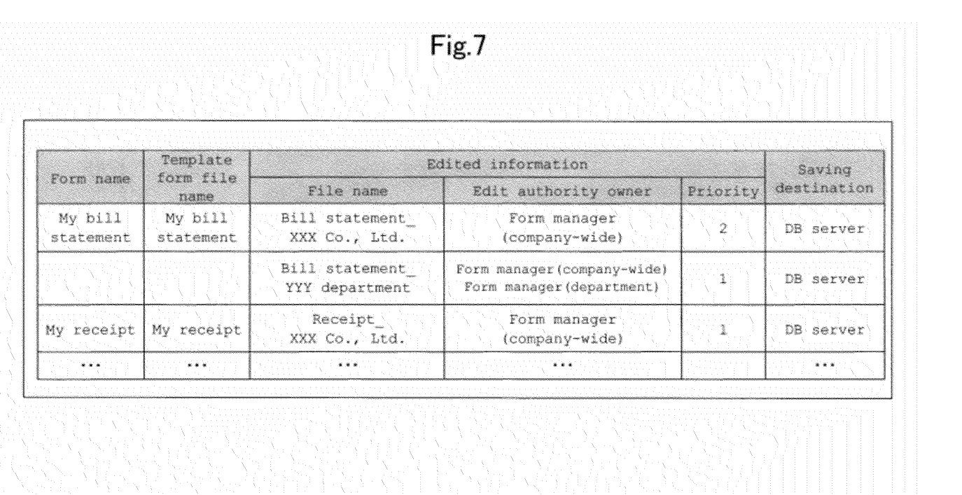

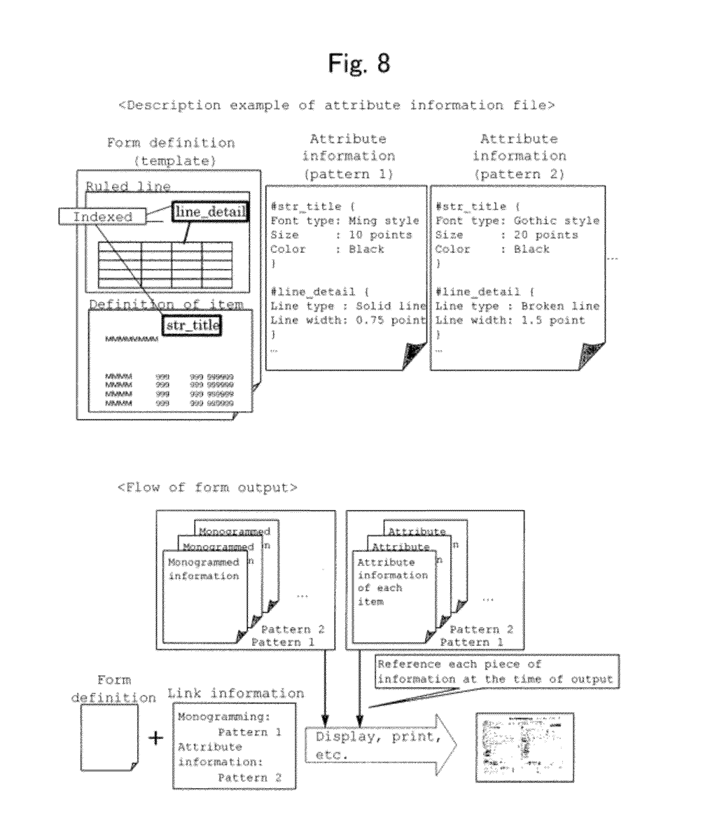

As exemplified in FIG. 7, the edited information registration unit 506 of the present embodiment stores a file name, an edit authority owner, and priority of the edited information in the edited information recording device 12 in condition where they are correlated with a form name, a template file name, and a saving destination. The priority is information which specifies an edit application order sequence number and denotes a priority sequence number in a case where editing goes competitive. Further, as shown in FIG. 8, the edited information includes attribute information (for example, a font type, a font size, a color, a line type, or a line width), which is contents of the edit processing, and information (an index or image position information) which is used to identify an image element to be edited. As exemplified in FIG. 8, the edited information in the present embodiment may be a monogramming layer in which an added image element (monogrammed information) is disposed or an attribute layer in which the attribute information is correlated with a position of the image element.

The authority management unit 508 manages an edit authority on the image element of a form or attributes of the image element. More specifically, for each of forms edited by a group of the user (for example, a company), the authority management unit 508 manages the authority to edit the image element of each form or the attributes for the user belonging to the group. As exemplified in FIG. 3B, the authority management unit 508 of the present embodiment gives the different authorities for the different image elements to the users (a company-wide form manager, a department form manager, and a form provider) and permits/refuses the editing of each image element by each of the users.

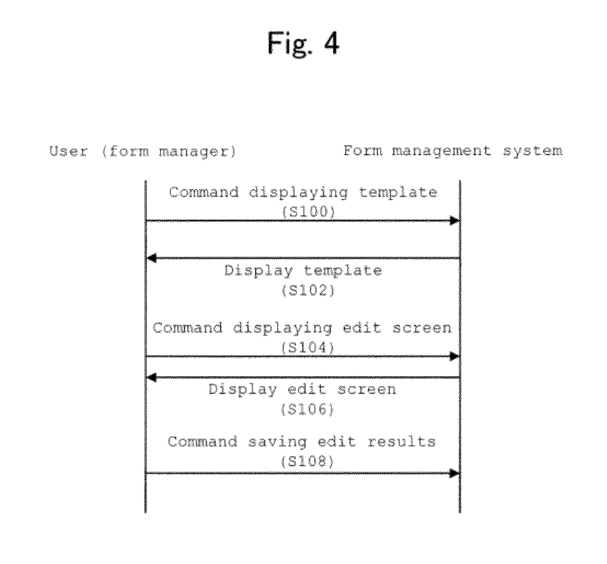

FIG. 4 is the sequence diagram of a form edit phase. As shown in FIG. 4, if the user operates the client terminal 9 to command displaying a template of a form (S100), in accordance with the command from the user, the form providing device 10 in the form management system 1 permits the client terminal 9 to display the form template stored in the template database 100 (S102).

If the user operates the client terminal 9 to command performing edit processing on the displayed template (that is, selected template) (S104), in accordance with the edit command from the user, the form providing device 10 in the form management system 1 performs the edit processing on the selected template and permits the client terminal 9 to display the edited template (customized template) (S106).

If the user operates the client terminal 9 to command saving of the edited template (S108), in accordance with the saving command, the form providing device 10 in the form management system 1 stores edited information (monogrammed information or attribute information) corresponding to the edit processing in the edited information recording device 12.

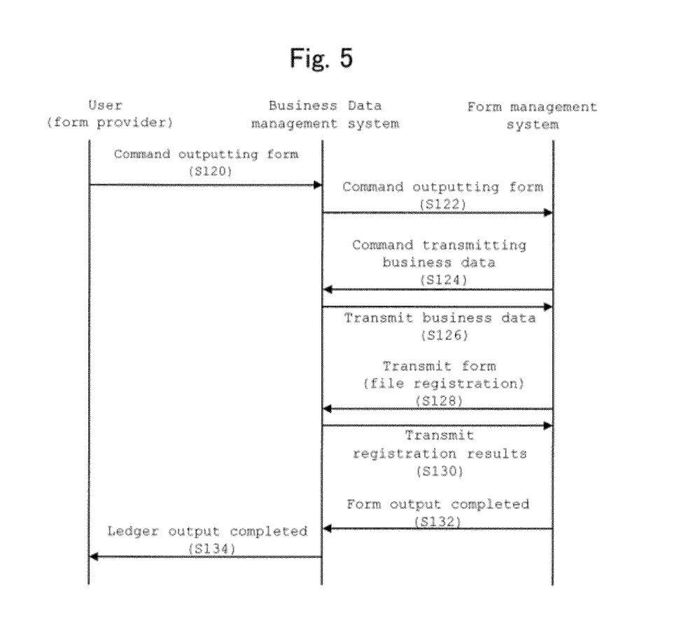

FIG. 5 is the sequence diagram of a form output phase.

As exemplified in FIG. 5, if the user operates the client terminal 9 to transmit a form output command to the business data management system 2 (S120), the business data management system 2 command the form management system 1 to output a form (S122).

In accordance with the form output command, the form management system 1 generates a customized form and requests the business data management system 2 to transmit business data to be inserted into the generated form (S124). In accordance with the transmission request, the business data management system 2 transmits the business data to be inserted into the form to the form management system 1 (S126).

The business data management system 1 inserts the received business data into the generated form and transmits the form into which the business data is inserted to the business data management system 2 (S128).

When having registered the form transmitted from the form management system 1, the business data management system 2 notifies the form management system 1 of successful registration (S130).

When the form management system 1 has notified the business data management system 2 of completion of output of the form (S132), the business data management system 2 notifies the user's client terminal 9 of the completion of output of the form (S134).

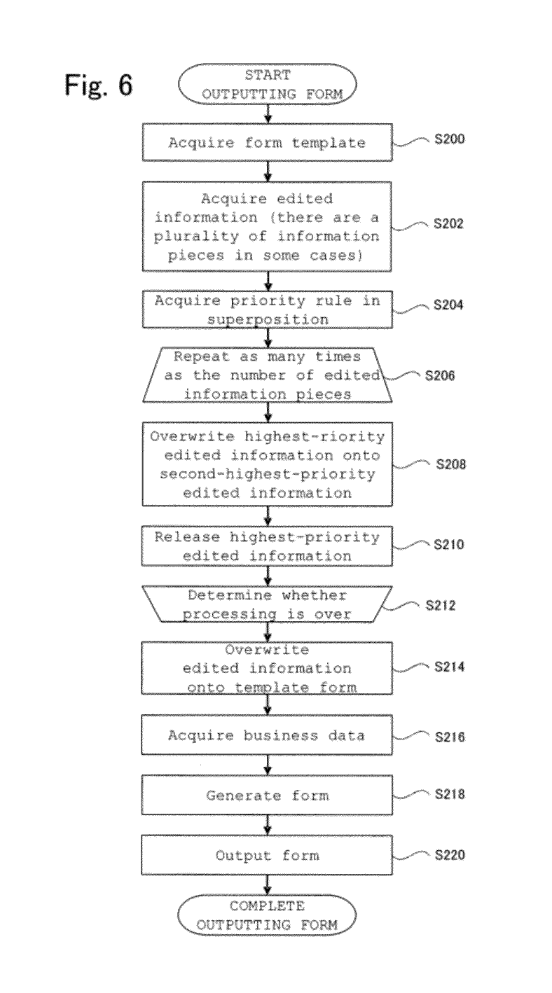

FIG. 6 is an explanatory flowchart of operations of the form providing device 10 at the time of outputting the form.

As exemplified in FIG. 6, in step 200 (S200), the form providing unit 504 in the form providing device 10 reads the form template selected by the user from the template database 100.

In step 202 (S202), the form providing unit 504 reads out edited information (customized information) of the selected form from the edited information database 120. The edited information that is read out may include a plurality of pieces of monogrammed information and attribute information in some cases.

In step S204 (S204), the form providing unit 504 acquires a priority rule (“priority” in FIG. 7) of the edited information that is read out.

In step 206 (S206), the form providing unit 504 repeats processing of S208 through S210 as many times as the number of pieces of the edited information that is read out and superposes the edited information in accordance with the priority.

Specifically, in step 208 (S208), the form providing unit 504 writes a piece of edited information with the highest priority among the edited information pieces that are read out over a piece of edited information with the second highest priority.

In step 210 (S210), the form providing unit 504 releases a piece of edited information with the highest priority among the edited information pieces that are read out as something that is already applied. That is, the form providing unit 504 sequentially superposes the higher-priority pieces of edited information and sequentially excludes the superposed pieces of edited information.

In step 212 (S212), the form providing unit 504 determines whether all of the edited information is superposed and, if it is superposed, makes the shift to processing in S214.

In step 214 (S214), the form providing unit 504 writes the superposed edited information over the read-out template.

In step 216 (S216), the form providing unit 504 acquires business data to be inserted into the form from the business data management system 2.

In step 218 (S218), the form providing unit 504 inserts the acquired business data into the template (completed form) overwritten with the edited information.

In step 220 (S220), the form providing unit 504 provides the user's client terminal 9 with the form into which the business data is inserted.

As described hereinabove, the form management system 1 of the present embodiment can streamline form creation or operation by managing a form in condition where its form template and information (customized information) about edit processing on this template are separated from each other.

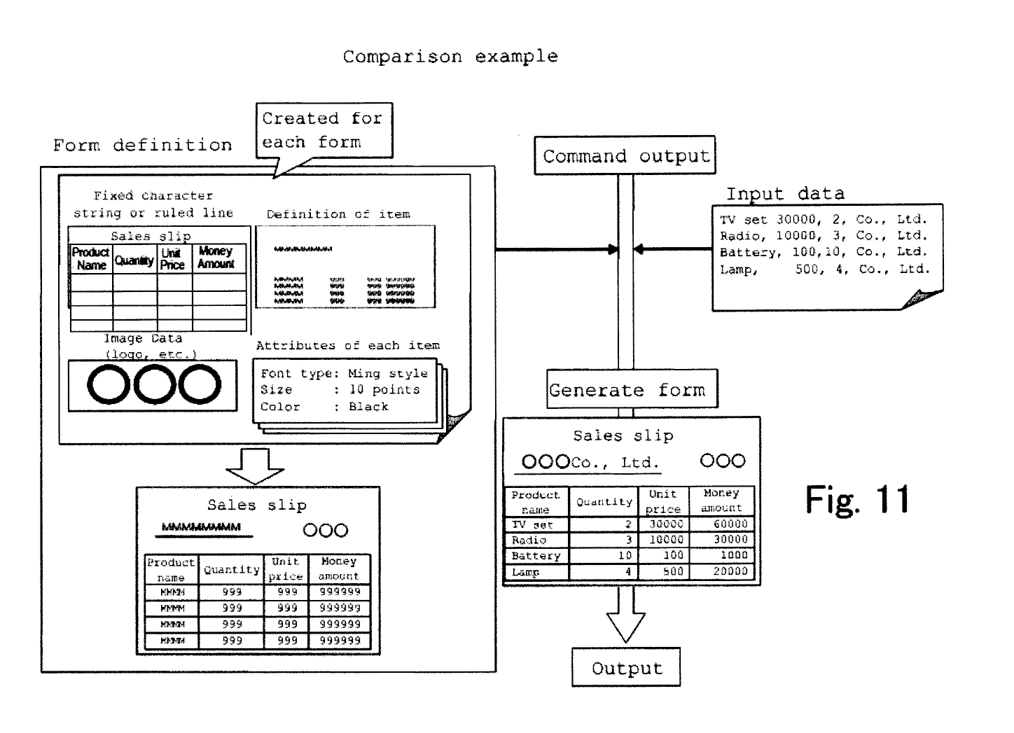

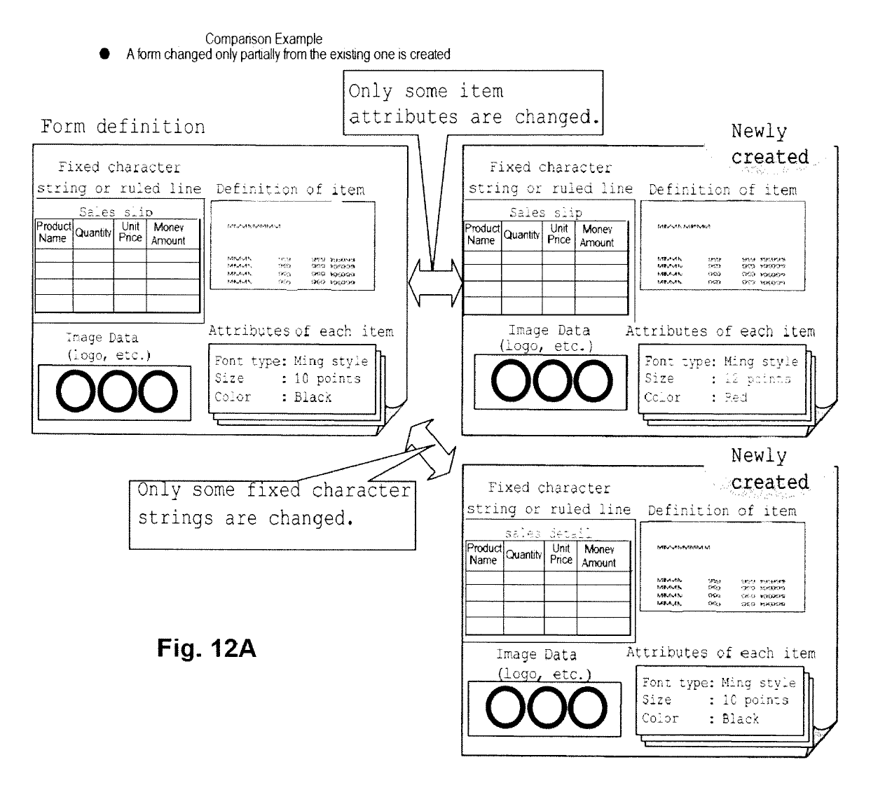

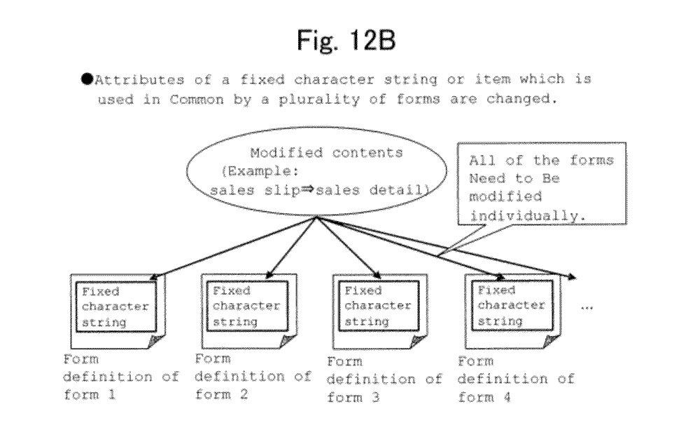

FIG. 11 is the explanatory diagram of a comparison example of the form providing method and FIG. 12 is the explanatory diagram of problematic points of the comparison example.

As the comparison example, an aspect may be possible in which a form definition is created for each form and input data (business data) is inserted into the form to then output it as shown in FIG. 11. That is, in this aspect, only the input data is a variable portion and the form definition is fixed. In this case, as exemplified in FIG. 12, if only some of the attributes (font size and color) of the form definition are changed or some of the fixed character strings are changed (“from “sales slip” to “sales detail”), the form definition needs to be created newly for each of them. That is, even in the case of a form which is changed only partially from the existing one, it is necessary to separately create monogrammed information and information on, for example, attributes for each item. Further, in the case of making the monogrammed information and the attribute information for each item common to a plurality of forms, it is necessary to individually change the information of each form each time it is changed. That is, it requires time and efforts to create and maintain the form.

Further, it is necessary to be familiar with a lot of knowledge about form definitions in order to create or edit a form; further, even in the case of newly creating a form by using the existing form as a base, it is still necessary to be familiar with the knowledge about the form definitions in order to understand points to be edited. That is, it requires skills to create and maintain the forms.

Moreover, also in a case where it is necessary to change fixed character strings or attributes which are utilized in common by a plurality of forms, it is necessary to change the fixed character string and attributes for each of the forms as exemplified in FIG. 12.

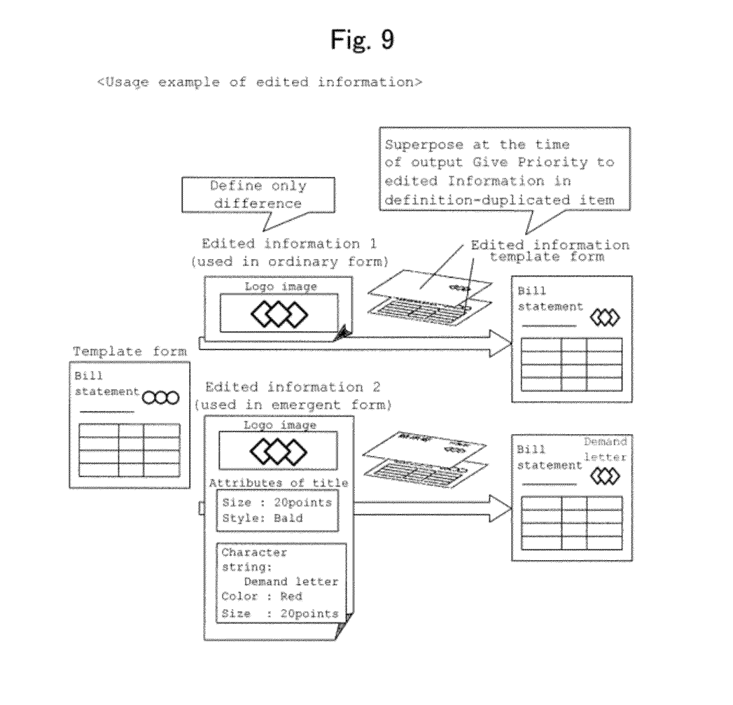

In contrast, as exemplified in FIG. 9, the form management system 1 of the present embodiment manages a difference (monogrammed information or item attribute information) with respect to a template (form definition) in condition where it is separated from the template, thereby enabling using the difference (that is, customized information) in common and re-utilizing it. In particular, it is well suited for applications in a case where a group such as a company or a department uses a common logo, font, or a telephone number (fixed character string).

Further, the form management system 1 can manage a portion (unedited template portion or edited information commonly applied) common to a plurality of forms as a single data file, thereby suppressing the data size in management of definitions of the forms.

Further, as described above, even in a case where a template is made open to the outside so that it may be utilized, the customized information such as monogrammed information and attribute information may be desired to be managed by its owner in many cases. Accordingly, the form management system 1 of the present embodiment stores the customized information in a storage device (edited information storage device whose security is ensured by a firewall, etc.) different from the template, thereby preventing a company logo, etc. from being used illegally. It is well suited also in the viewpoint of managing the copyright of edited portions (for example, logo specific to the company).

The form management system 1 of the present embodiment manages an edit authority for each image element of a form in order to add the edit authority to each of the users corresponding to their skills and responsible areas in a case where there are differences among their skills in form editing, thereby enabling reduction in business troubles. Moreover, the form management system 1 sets priority to edited information, thereby enabling edit processing corresponding to skills or responsible areas or hierarchical re-editing corresponding to a situation peculiar to a sub-group such as a department.

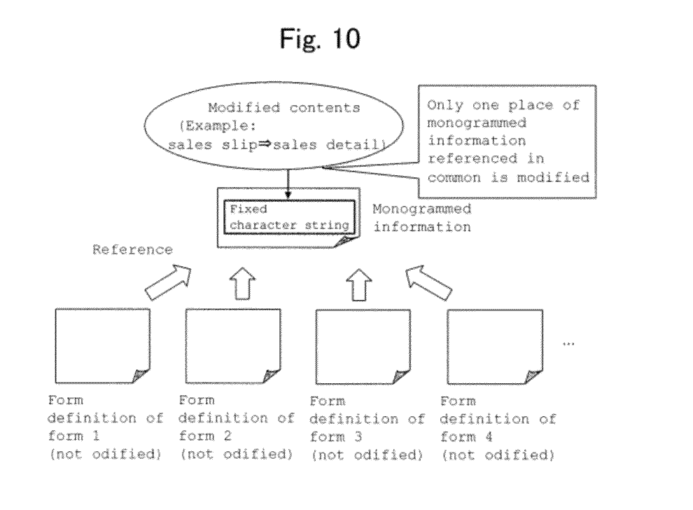

Further, as exemplified in FIG. 10, a plurality of forms can be edited uniformly even if it is necessary to change fixed character strings or attributes which are utilized in common by those forms, thereby improving a business efficiency of form update.

### [Variant 1]

Next, a description will be given of a variant of the embodiment described above.

The above embodiment has been described with reference to an aspect in which edited information would be stored in the edited information recording device 12 in the form management system 1; however, the edited information may be stored in the user's client terminal 9. It is well suited for applications in a case where the user would not like to save the company log externally.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A form providing device comprising:
a template storage unit that stores a template of a form;
an edited information storage unit that stores information about edit processing on the template selected by a user in condition where it is correlated with the selected template; and
a form providing unit that provides an edited form to the user based on the information about the edit processing stored in the edited information storage unit and the template correlated with this information.

2. The form providing device according to claim 1, further comprising:
an edit unit that performs edit processing on a user-selected template out of the templates stored in the template storage unit in accordance with a command from the user,
wherein the edited information storage unit stores the information about the edit processing performed by the edit unit on the template in condition where it is correlated with this template.

3. The form providing device according to claim 2, wherein the edit unit performs addition of an image element to the template or alteration of attributes of the image element of the form; and
wherein the edited information storage unit stores the image element added to the template or attribute information denoting the changed attributes as the information about the edit processing.

4. The form providing device according to claim 1, wherein the edited information storage unit stores the information in condition where its security level is higher than that of the template storage unit.

5. The form providing device according to claim 1, wherein the edited information storage unit stores the information in a recording device physically separated from the template storage unit.

6. The form providing device according to claim 2, further comprising:
an authority management unit that manages an edit authority for the image element of the form or its attributes,
wherein the edit unit permits or refuses the edit processing on the template in accordance with the edit authority managed by the authority management unit.

7. The form providing device according to claim 6, wherein the authority management unit manages the authority to edit the image elements or attributes of each form on the user belonging to a group about each of the forms edited by the user group; and
wherein the edit unit permits or refuses the edit processing on the image elements or attributes of the edited form in accordance with the user's edit authority about the forms edited by the group.

8. A form providing device comprising:
a first storage unit that stores a form definition including at least a basic layout of a form;
a second storage unit that stores an image element added to the form definition selected by a user or attribute information of the image element of the selected form definition in condition where it is correlated with the selected form definition; and
a form providing unit that provides the form to the user based on the image element or attribute information stored in the second storage unit and the form definition stored in the first storage unit.

9. A form providing method comprising the steps of:
selecting a template from the templates of forms;
performing edit processing on the selected template in response to a command from a user;
storing information about the edit processing in a storage device different from the template; and
providing the form to the user based on the stored information about the edit processing and the selected template.

10. A non-transitory computer-readable medium storing thereon a computer program used in a computer, the computer program causing the computer to perform the steps of:
selecting a template from the templates of forms;
performing edit processing on the selected template in response to a command from a user;
storing information about the edit processing in a storage device different from the template; and
providing the form to the user based on the stored information about the edit processing and the selected template.
